(19) United States
(12) Patent Application Publication
(10) Pub. No.: US 2012/0147008 A1
(43) Pub. Date: Jun. 14, 2012

(54) NON-UNIFORMLY SAMPLED 3D INFORMATION REPRESENTATION METHOD

(76) Inventors: Huei-Yung LIN, (US); Yu-Hua Hsiao, (US)

(21) Appl. No.: 13/150,670

(22) Filed: Jun. 1, 2011

(30) Foreign Application Priority Data
Dec. 13, 2010 (TW) 099143425

(51) Int. Cl. G06T 15/20

(52) U.S. Cl. 345/427

(57) ABSTRACT

A non-uniformly sampled three-dimensional (3D) information representation method is revealed. Firstly, use a computer to reconstruct a 3D model according to a 3D model data. Then set up a projection point according to the 3D model. The projection point is projected onto the 3D mode so as to get a plurality of sampling points uniformly. Then create at least one 2D array data according to a plurality of horizontal parameters and a plurality of vertical parameters of a 3D sample model. The 2D array, data corresponds to the sampling points. Take samples from non-uniform area of the 3D model so as to generate a non-uniform element. Thus, the 3D model data is simplified and this is beneficial to representation, operation, storage and transmission of 3D data.

### BACKGROUND OF THE INVENTION

1. Fields of the Invention

The present invention relates to an image processing method, especially to a non-uniformly sampled three-dimensional (3D) information representation method.

2. Descriptions of Related Art

In research and patents related to data representation methods for 3D models, most of representation methods can be categorized as one of two groups—two basic 3D model representation methods. The first method involves a geometric representation for 3D models in which 3D models are represented by limited color texture data and a simple 3D model representation method. Thus only small amount of texture image data is required to complete the construction of the 3D model. But the 3D model has to be reconstructed first in order to get the geometric data. On the other hand, there are also 3D model representation which use texture images. Instead of geometric data, the texture image representation method for 3D models requires a large amount of texture image data to construct the texture images of the 3D model. The main difference between the above two methods is in that the geometric representation method focuses on data reduction while the texture image representation method emphasizes the quality of texture mapping.

However, no matter which method is used, it's difficult to have data reduction while keeping image details at the same time. As the data simplicity of the 3D model is achieved, the image details of the 3D model with higher complexity are significantly lost. On the other hand, in order to achieve the high quality of the texture mapping of the 3D model, a huge amount of texture image data is required, which has negative effects on the use of the texture image representation method. Either of the two conventional 3D reconstruction methods is not good for image operations, data storage or network transmission of 3D models, and thus is not suitable for multimedia systems.

Moreover, multimedia systems such as 3D video systems have gradually evolved into the innovations and applications of interactive videos. Users can interact with the 3D model by the multimedia system and select viewpoints freely. Yet the geometric representation method is unable to provide better image quality for the 3D model and the texture image representation method is not suitable for image operations, data storage as well as network transmission of the 3D model and applications to multimedia system. Therefore, the two methods are not ideal.

There is a need to develop a better representation method for 3D models that solves the above problems and provides better image operations, data storage and transmission efficiency of 3D models.

### SUMMARY OF THE INVENTION

Therefore it is a primary object of the present invention to provide a non-uniformly sampled three-dimensional (3D) information representation method that gets two-dimensional (2D) array data by taking samples from 3D models so as to simplify storage formats for 3D models and reduce data complexity. At the same time, the 2D array data corresponds to each sampling points of the 3D model to enhance details of the 3D model reconstructed by the non-3D model data.

It is another object of the present invention to provide a non-uniformly sampled three-dimensional (3D) information representation method that uses 2D array data to reconstruct 3D models with free viewpoint operations and image details that can be applied to multimedia interactive systems.

In order to achieve the above objects, a non-uniformly sampled three-dimensional (3D) information representation method of the present invention includes a plurality of steps. Firstly, reconstruct a 3D model using a computer according to a 3D model data. Then set up a projection point inside the 3D model and the projection point is corresponding to a plurality of sampling points of the 3D model. Next create a 3D sample model according to the projection point and the sampling points. Further generate at least one 2D array data by the computer according to a plurality of horizontal parameters and a plurality of vertical parameters of the 3D sample model. The 2D array data corresponds to the sampling points. Then take samples non-uniformly from at least one area of the 3D model according to the 3D sample model so as to generate at least one non-uniform element. The non-uniform element corresponds to both the 2D array data and the sampling points. A first dimension and a second dimension of the 2D array data are respectively corresponding to the horizontal parameters and the vertical parameters. Thus the storage format of image data of 3D model is simplified by the 2D array data, which makes network transmission and data access easier. Moreover, the 2D array data includes not only geometric data corresponding to the 3D model but also texture image data of the 3D model. This helps to enhance details of the 3D model reconstruction.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a flow chart of an embodiment according to the present invention;

FIG. 2 is a flow chart of another embodiment according to the present invention.

### DETAILED DESCRIPTION OF THE PREFERRED EMBODIMENT

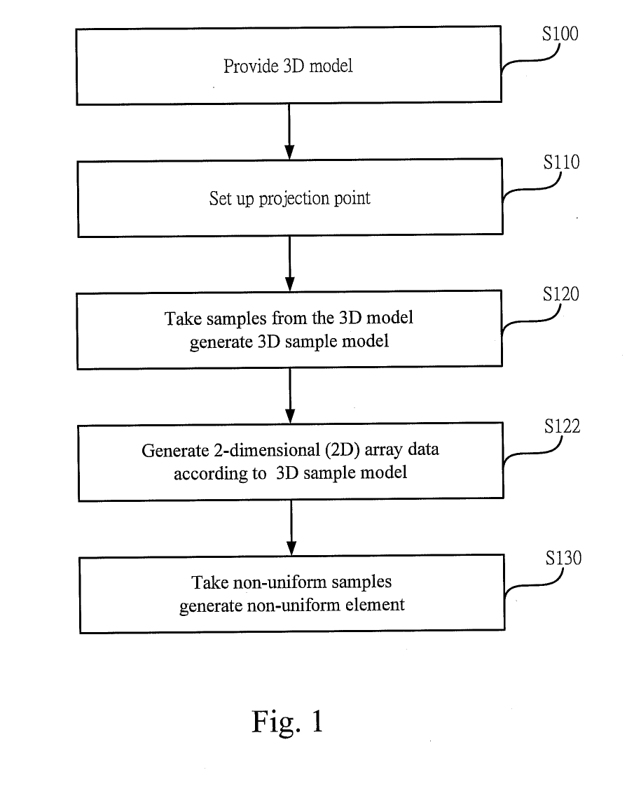

Refer to FIG. 1, a non-uniformly sampled 3D information representation method of the present invention is used to simplify the storage format of a 3D model. The non-uniformly sampled 3D information representation method includes a plurality of steps. Firstly, take the step S100, a computer receives a 3D model data and reconstruct a 3D model according to the received 3D model data. The 3D model data includes 3D coordinates of the 3D model, mesh topology data, and texture image data. Then take the step S110, set up a projection point on the 3D model. This projection point corresponds to a plurality of sampling points of the 3D model. In this embodiment, the projection point and those sampling points correspond to the Euclidean coordinate system and also a polar coordinate system, but not limited. Next refer to the step S120, the computer takes samples from the 3D model according to the center of mass and the sampling points so as to get a 3D sample model. The 3D sample model can be a 3D point cloud model. In the step S120, according to the projection point and the sampling points, a plurality of sample rays is used to generate the 3D sample model. Then, take the step S122, generate at least a 2-dimensional (2D) array data according to a plurality of horizontal parameters and a plurality of vertical parameters of the 3D sample model generated in the step S120. The 2D array data corresponds to those sampling points. And a first dimension of the 2D array data corresponds to the horizontal parameters of the 3D sample model while a second dimension of the 2D array data corresponds to the plurality of vertical parameters. The horizontal parameters are a plurality of horizontal angles of the 3D sample model and the vertical parameters are a plurality of vertical angles of the 3D sample model. The 2D array data records the plurality of sample data of the 3D model according to the horizontal angles and the vertical angles. These sample data corresponds to the sampling points. That means the sample data records a distance parameter and a color parameter of each sampling point respectively. Moreover, the plurality of 2D array data is generated according to the 3D sample model when at least one sample ray of the sample rays connects to different sampling points.

Later, run the step S130, according to the 3D sample model generated in the step S120, and a distance threshold value, the computer builds up at least one quadtree structure on an area of the 3D sample model that corresponds to a non-uniform area of the 3D model and take samples again so as to generate at least one non-uniform element. The non-uniform element corresponds to both the 2D array data and the sampling points.

Thereby, the present invention provides 2D array data used in reconstruction of 3D model. Moreover, the non-uniform element is used to improve details of the 3D model. And the storage form of the present invention is 2D array data whose complexity is much lower than data of the 3D model. This is beneficial to network transmission and data storage. The followings are examples of applications of the present invention applied to 3D model reconstruction.

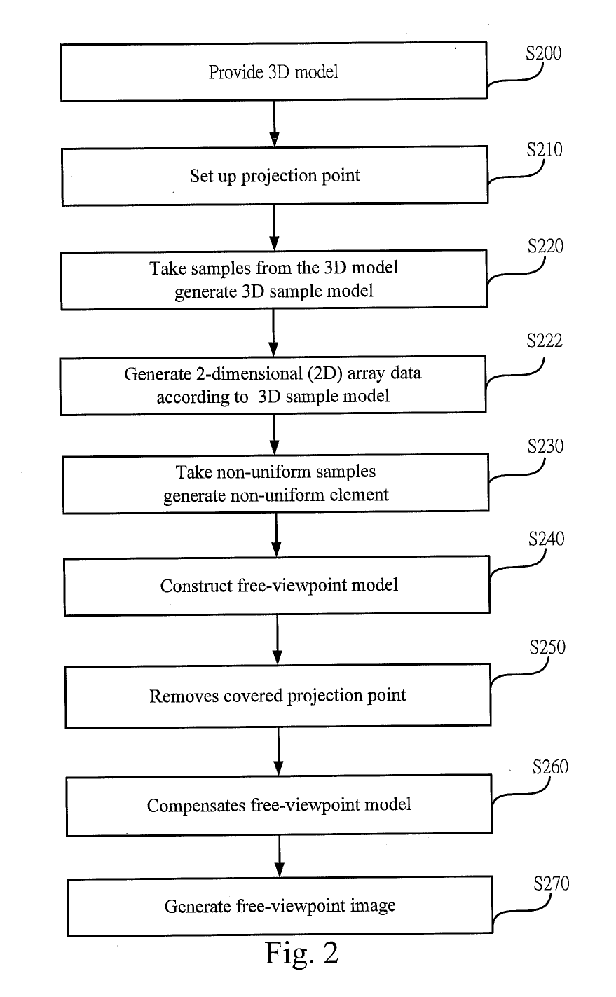

Refer to FIG. 2, a flow chart of another embodiment is revealed. The difference of this embodiment and the above one in FIG. 1 is in that this embodiment further includes a step of synthesizing the 3D model. As shown in the figure, a non-uniformly sampled 3D information representation method of the present invention is used to synthesize a 3D free-viewpoint model. Refer to the step S200, rebuild a three-dimensional (3D) model according to the 3D model data. The 3D model includes a plurality of sampling points and the 3D model data includes 3D coordinates of the 3D model, mesh topology data, and texture image data. Then, take the step S210, set up a projection point by a first computer according to the 3D model. This projection point is corresponding to a plurality of sampling points of the 3D model. The first computer arranges the projection point at the 3D model by a polar coordinate system, and projects the projection point to the plurality of sampling points through a plurality of rays. Next, refer to the step S220, the first computer takes samples from the 3D model according to the projection point and the sampling points so as to generate a 3D sample model. Then, take the step S222, the first computer produces at least one two-dimensional (2D) array data according to the 3D sample model generated in the step S220. A first dimension and a second dimension of the second array data correspond to the sampling points. The 2D array data generated from the 3D sample model is corresponding to the 3D model data because the 3D sample model is corresponding to the 3D model data. Refer to the step S230, according to the 3D sample model generated in the step S220, and a distance threshold value, the first computer builds up at least one quadtree structure and takes samples again from at least one non-uniform area so as to generate at least one non-uniform element. The non-uniform element is corresponding to both the 2D array data and the sampling points.

Then, refer to the step S240, a second computer reads the 2D array data and the non-uniform element of the first computer to construct a free-viewpoint model according to the 2D array data, the non-uniform element and the sampling points. The free-viewpoint model is corresponding to the 3D model data, and is a 3D point cloud model. For example, a server completes from the step S210 to the step S230 to generate the 2D array data and the non-uniform element. A user's computer reads the 2D array data and the non-uniform element of the server through a network. Then, as shown in the step S250, the second computer removes at least one covered projection point of the free-viewpoint model. Refer to the step S260, the second computer compensates the free-viewpoint model by means of an interpolation technique. For example, the free-viewpoint model is compensated by using the bilinear interpolation. Refer to the step S270, the second computer generates a free-viewpoint image according to the free-viewpoint model.

The followings are examples and detailed description of 3D model reconstruction, and 3D sampling.

The 3D model is reconstructed according to a multi-view imaging methodology. This methodology is based on using a plurality of cameras to obtain images of scenes and objects in the real world. After 3D reconstruction, a 3D reconstruction model with virtual reality and easiness of observation is generated. The multi-view imaging methodology is often applied to 3D model reconstruction or production of interactive multimedia products. The advantage of using the captured images to reconstruct the 3D model is that the reconstructed scene model is more complete and more detailed. However, without being processed, the amount raw data of the 3D scene model is quite huge, not suitable for data access, transmission and operation. Thus, the 3D model reconstructed by the present invention uses 3D coordinates (x, y, z), texture image data, and 3D mesh topology data as input data so as to perform full-field resampling and represent the 3D reconstruction model in a new way, as shown in the attachment 1. This is a front view of the 3D reconstruction model generated according to the 3D model data.

The 3D sampling of the present invention is divided into two groups—uniform 3D sampling and non-uniform 3D sampling. Firstly, the execution way and advantages of the uniform 3D sampling are described.

### Uniform 3D Sampling

After the 3D coordinates, a mesh topology data, and a texture image data of the 3D model (the so-called 3D model data) being input into the computer, operate the computer to use a center of mass of the 3D model as a sphere center (this embodiment uses the center of mass as the projection point), and sample rays at different angles between the direction angle θ, 360 degrees, and the angle of elevation ψ180 degrees to take samples from the 3D model, based on the polar coordinate system, as shown in the attachment 2. The sample rays are emitted from the sphere center (the center of mass of the 3D model) at different angles θ, ψ to be intersected with the 3D model. The sampling data of each sampling point is further obtained. Thus, the 3D model and the 2D array data, which are obtained after uniform sampling, are shown in attachments 3A and 3B. The attachment 3A is the 3D model constructed according to the input 3D model data while the attachment 3B is a 3D point cloud model obtained by uniform sampling in the polar coordinate system.

The data structure of sample data obtained by sampling is stored in a 2D array. The stored result is shown in the attachment 4. In the 2D array data, the direction angle θ is served as the first dimension, which is the X axis, and the elevation angle ψ is served as the second dimension, which is the Y axis. Each array unit of the 2D array data records the sample data of the corresponding sampling point according to angles (θ, ψ) of the sample rays, including the distance between the sampling point and the origin of the coordinate system, and color data of the corresponding sampling point such as RGB color data. For example, refer to the attachment 2, the distance ρ between the sphere and the sampling point. Thus, sample data of each sampling point in the 3D model is represented by the 2D array data shown in the attachment 4. In each array unit, the distance ρ and RGB color data corresponding to each sampling point based on the same data structure are stored as geometric data and texture image data respectively.

As to more complex 3D models, the uniform sampling result is stored in a plurality of 2D array data for storage. The 2D array data is also obtained through the above uniform sampling based on the polar coordinate system. Refer to the attachment 5, for the complicated 3D model, the sample rays at the angles (θ, ψ) emitted from the center of mass of the 3D model and the 3D model surface do not intersect at a point, compared with the sample rays at the angles (θ, Ψ). There are several points. Thus, as shown in the attachment 6, the present invention includes different layers of images divided according to the intersection points. A plurality of 2D array data is used to store different layers of images so as to solve the data storage and data representation problem in such models. At the same time, the storage complexity of the 3D model is reduced by the multi-layered data representation method.

The above multi-layered data representation method uses 2D array data having the direction angle θ in the X axis and the elevation angle ψ in the Y axis to record 3D data of each sampling point. In order to solve the problem of multiple intersection points, the multi-layered data representation method uses a single (θ, ψ) 2D array data as a base. According to the sampling order of the intersection points between the sample rays and the 3D model surface, a plurality of single (θ, ψ) 2D array data is stacked at the same order so as to solve the problem that the sample ray at the same angle has multiple sampling intersection points. The results are shown in the attachment 7A and the attachment 7B. In the attachment 7A, the texture image data shows that the model includes four layers of 2D array data. The horizontal axis of each 2D array data represents the direction angle θ, and the vertical axis is the elevation angle ψ. According to stored positions of data with different angles (θ, ψ) in the 2D array data, RGB color data of each intersection point obtained at the angles is filled. Similarly, the geometric data of the attachment 7B is filled with the value of the distance ρ between the sampling intersection point and the sampling coordinate origin. The present invention quantifies the ρ value between 0 and 255, represented by a gray-level value. The darker the gray level is, the larger the ρ value is, and the farther from the origin. The storage position without sampling intersection point is filled with blue color.

### Non-Uniform 3D Sampling

The non-uniform 3D sampling method of the present invention takes additional samples from the model surface with lower sampling density so as to improve details of the 3D model while reconstructing the 3D model. A quadtree method of the present invention takes additional samples from the 3D model by quadtree structure. As shown in the attachment 8, the distance threshold is used as a criterion for non-uniform 3D sampling. Based on the uniform 3D sampling intersection points whose values are larger than the distance threshold, take samples from the surface of the 3D reconstruction model around the uniform 3D sampling intersection points by means of quadtree structure. The results are shown in the attachment 9A, the attachment 9B, the attachment 9C, and the attachment 9D.

The attachment 9A is the input 3D reconstruction model, the attachment 9B is the result of uniform 3D sampling based on the polar coordinate representation, and the attachment 9C is the 3D point cloud model of non-uniform 3D sampling based on the quadtree structure. The 3D point cloud model uses the distance threshold as a sampling criterion for the quadtree structure. Use a quadtree structure to perform the non-uniform sampling once. The attachment 9D is the result of performing two times of non-uniform sampling by means of the quadtree structure. Compared with the attachment 9C, it is found that the attachment 9D is more detailed than the attachment 9C. The data of the sampling points obtained by non-uniform 3D sampling is stored and recorded by multi-layered 2D array data with variable-resolution, based on the above multi-layered 2D array data, as shown in the attachment 10.

### Free-Viewpoint Image Synthesis

Compared with the 3D reconstruction model built according to the 3D model data, the data pattern of the above multi-layered 2D array data obtained by uniform 3D sampling and non-uniform 3D sampling algorithms in the polar coordinate system is more concise and simpler. The 3D point is only stored in the format of multi-layered 2D array data. Thus, these 2D array data is getting easier to be transmitted to various user ends through the network. And the access speed is improved. Moreover, the multi-layered 2D array data is independent from one another. Refer to the above attachments 7A and 7B, it is found that most of the important information of the 3D model are focused on the first layer of the 2D array data. Thus, it is not necessary for the user to get all 2D array data for viewing the 3D model while the user end is waiting for the transmission of the data.

Moreover, as to the present invention, the 3D information stored in the 2D array are applied to synthesize free-viewpoint images. That means to set up data of 3D point cloud model. By the way of setting up free viewpoint, visible 3D points within the viewpoint are kept. Then, the occluded 3D points are removed, and the visible 3D points are projected onto a 2D image plane. At last, synthesize the 2D image associated with the viewpoint by bilinear interpolation so as to interact with users. Refer to the attachment 11A, the attachment 11B and the attachment 11C, these are 3D point cloud models reconstructed by means of the distance ρ and the RGB color data recorded in the 2D array data and corresponding to different rays with various angles (θ, ψ). These 3D points are left after setting a viewpoint and removing the occluded points outside the viewpoint. The attachment 11A is a 3D reconstruction model, the attachment 11B shows uniformly sampled 3D points after removing occluded points to the viewpoint (or invisible points to the viewpoint), and the attachment 11C shows non-uniformly sampled 3D points after removing occluded points with respect to the viewpoint (or invisible points to the viewpoint).

After removing occluded points with respect to the viewpoint (or invisible points to the viewpoint), the left 3D point cloud is projected onto an image plane by the projection formula. Then, according to different requirements and connections among projection points learned by geometric data, draw pixels between the projection points by interpolation to complete the synthesis of the projected image. The attachment 12A is a 2D image synthesized by projection of the result shown in the attachment 11B. The attachment 12B is a 2D image synthesized by projection of the result shown in the attachment 11C.

The multi-layered 2D array data submitted by the present invention makes users use 3D data stored in the 2D array to have free-viewpoint interaction and applications. Moreover, the multi-layered 2D array data obtained by uniformly 3D sampling and the multi-layered 2D array data with variable resolution obtained by non-uniformly 3D sampling further allow users to get 3D point data with different levels of detail by the above non-uniformly 3D sampling strategy. Thus, the images which match the screen resolution are displayed during image synthesis processes, as shown in the attachment 12B.

In summary, a non-uniformly sampled 3D information representation method of the present invention creates 2D data by taking samples from a 3D model so as to reduce processing complexity of 3D model reconstruction and improve network transmission efficiency. The 2D data is the 2D data array in the present invention. Moreover, the simpler 2D array data is used for 3D free-viewpoint model synthesis and this is beneficial to operation of the viewpoint of the 3D model. Furthermore, the details of the reconstructed 3D model are not affected by the simplified storage format of the 3D model. In addition, the present invention has following advantages:
1. The 3D information representation technique of the present invention is based on both geometric structure and the texture image.
2. According to the different requirements of details of the 3D model, polar coordinate representation at different angles and 3D resampling by quadtree structure are performed.
3. The multi-layered data representation method (use a plurality of 2D array data to represent the 3D model) dramatically reduces data amount of the multi-view 3D reconstruction model and simplifies the geometric structure of the 3D reconstruction model.
4. The independency among multiple layer 2D array data is beneficial to the improvement of the network transmission efficiency and data access efficiency.
5. The details of the 3D model are significantly improved by the quadtree sampling of the 3D model.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A non-uniformly sampled three-dimensional (3D) information representation method comprising the steps of:
providing a 3D model;
using a first computer to set up a projection point according to the 3D model and the projection point corresponds to a plurality of sampling points of the 3D model;
using the first computer to take samples from the 3D model according to the projection point and the sampling points are used to generate a 3D sample model;
using the first computer to create at least one two-dimensional (2D) array data according to a plurality of horizontal parameters and a plurality of vertical parameters of the 3D sample model and the 2D array data corresponds to the sampling points; and
using the first computer to take samples non-uniformly from at least one area of the 3D model according to the 3D sample model so as to generate at least one non-uniform element, and the non-uniform element corresponds to both the 2D array data and the sampling points;
wherein a first dimension of the 2D array data corresponds to the horizontal parameters and a second dimension of the 2D array data corresponds to the vertical parameters.

2. The method as claimed in claim 1, wherein in the step of using the first computer to take samples non-uniformly from at least one area of the 3D model according to the 3D sample model, set up at least one quadtree structure and resample from the area of the 3D model according to the 3D sample model and a distance threshold so as to generate the non-uniform element.

3. The method as claimed in claim 1, wherein in the step of using a first computer to set up a projection point according to the 3D model, the first computer establishes a polar coordinate system according to the 3D model and sets up the projection point in the polar coordinate system for the 3D model.

4. The method as claimed in claim 1, wherein the 3D sample model is a 3D point cloud model.

5. The method as claimed in claim 1, wherein the horizontal parameters are a plurality of horizontal angles of the 3D sample model and the vertical parameters are a plurality of vertical angles of the 3D sample model.

6. The method as claimed in claim 1, wherein the 2D array data records a plurality of sample data according to the first dimension and the second dimension and the plurality of sample data respectively includes a distance parameter and a color parameter.

7. The method as claimed in claim 1, wherein the non-uniformly sampled three-dimensional (3D) information representation method further includes the steps of:
using a second computer to set up a free-viewpoint model according to the 2D array data and the non-uniform element while the free-viewpoint model is corresponding to the 3D model;
using the second computer to remove at least one occluded point of the free-viewpoint model;
using the second computer to compensate the free-viewpoint model; and
using the second computer to generate a free-viewpoint image according to the free-viewpoint model.

8. The method as claimed in claim 7, wherein the free-viewpoint model is a 3D point cloud model.

9. The method as claimed in claim 7, wherein in the step of using the second computer to compensate the free-viewpoint model, the second computer uses an interpolation technique to compensate the free-viewpoint model so as to generate the free-viewpoint image.
